(19) United States
(12) Patent Application Publication
(10) Pub. No.: US 2026/0115739 A1
(43) Pub. Date: Apr. 30, 2026

(54) ANNULAR NOZZLE AND SUBSTRATE PROCESSING DEVICE

(71) Applicant: SwaySure Technology Co., Ltd., Shenzhen (CN)

(72) Inventor: Takayuki FUKASAWA, Shenzhen (CN)

(21) Appl. No.: 19/302,584

(22) Filed: Aug. 18, 2025

(30) Foreign Application Priority Data
Oct. 24, 2024 (CN) 202411499947.1

(51) Int. Cl. B05B 1/14; B05C 5/02; B05C 9/14

(52) U.S. Cl. CPC B05B 1/1423; B05B 1/1422; B05C 5/02; B05C 9/14

(57) ABSTRACT

An annular nozzle including an annular sleeve and N diffusion plates. The annular sleeve includes an outer cylinder, an inner cylinder, and an end plate. The inner cylinder is provided inside the outer cylinder. The end plate is provided at one end of the outer cylinder and the inner cylinder. The N diffusion plates are provided in the annular space formed between the outer cylinder and the inner cylinder. The annular sleeve is provided with a gas inlet hole, which is located on the side of the first diffusion plate close to the end plate. Each diffusion plate is provided with a plurality of exhaust holes surrounding the inner cylinder. For any two adjacent diffusion plates: the exhaust holes are provided in a staggered manner, and the number of exhaust holes on the diffusion plates increases sequentially in the direction away from the end plate.

### CROSS-REFERENCE TO RELATED APPLICATIONS

This application claims priority to Chinese Patent Application No. 202411499947.1, filed on Oct. 24, 2024, the entire disclosure of which is hereby incorporated herein by reference.

### TECHNICAL FIELD

The present disclosure belongs to the technical field of semiconductor manufacturing device, and specifically relates to an annular nozzle and a substrate processing device.

### BACKGROUND

Epitaxial Growth (EPI) is a technology for growing single-crystal thin films with the same crystal structure and orientation on a single-crystal substrate. During epitaxial growth, to ensure uniform film thickness, the gas flow field in the reaction chamber needs to be strictly controlled to make the distribution of reaction gases above the substrate as uniform as possible.

### SUMMARY

There are provided an annular nozzle and a substrate processing device. The technical solution is as below:

According to a first aspect of embodiments of the present disclosure, there is provided an annular nozzle, which includes:
an annular sleeve, including an outer cylinder, an inner cylinder, and an end plate; wherein the inner cylinder is provided inside the outer cylinder, an annular space is formed between the outer cylinder and the inner cylinder, and the end plate is provided at one end of the outer cylinder and the inner cylinder, and the end plate connects the outer cylinder and the inner cylinder; and
N diffusion plates provided in the annular space, wherein N is greater than or equal to 2, the N diffusion plates are sequentially spaced apart in a direction away from the end plate, a first diffusion plate is closest to the end plate among the N diffusion plates; the annular sleeve is provided with a gas inlet hole, and the gas inlet hole is located on a side of the first diffusion plate close to the end plate;
each diffusion plate is provided with a plurality of exhaust holes surrounding the inner cylinder; and
for any two adjacent diffusion plates, the plurality of exhaust holes are provided in a staggered manner, and the number of exhaust holes on each diffusion plate increases sequentially in a direction away from the end plate.

According to a second aspect of embodiments of the present disclosure, there is provided a substrate processing device, which includes:
a reaction chamber, including an upper chamber and a lower chamber in communication with each other;
a susceptor provided in the lower chamber, wherein the susceptor is configured to support a substrate to be processed;
the annular nozzle provided in the upper chamber, wherein the Nth diffusion plate is the farthest from the end plate among the N diffusion plates and is located on a side of the first diffusion plate closer to the susceptor; and
a gas intake assembly connected to the gas inlet hole of the annular nozzle, wherein the gas intake assembly is configured to introduce process gas.

It should be understood that the foregoing general description and the following detailed description are only exemplary and explanatory, and should not limit the present disclosure.

### BRIEF DESCRIPTION OF THE DRAWINGS

The accompanying drawings herein are incorporated into the specification and constitute a part of the specification, illustrating embodiments consistent with the present disclosure, and are used together with the specification to explain the principles of the present disclosure. Obviously, the drawings described below are only some embodiments of the present disclosure, and those skilled in the art can obtain other drawings based on these drawings without creative efforts.

FIG. 1 is a three-dimensional schematic diagram of the annular nozzle in an embodiment of the present disclosure.

FIG. 2 is a bottom-up schematic diagram of the annular nozzle in an embodiment of the present disclosure.

FIG. 3 is a cross-sectional schematic diagram of the annular nozzle in an embodiment of the present disclosure.

FIG. 4 is a structural schematic diagram of the substrate processing device in an embodiment of the present disclosure.

FIG. 5 is a schematic diagram of the distribution of process gases from top to bottom in the reaction chamber in an embodiment of the present disclosure.

FIG. 6 is a cross-sectional schematic diagram of the conical annular nozzle in an embodiment of the present disclosure.

FIG. 7 is a structural schematic diagram of the flow equalizing plate in an embodiment of the present disclosure.

### REFERENCE NUMBERS

100. Annular nozzle; 110. Annular sleeve; 111. Outer cylinder; 1111. Gas inlet hole; 112. Inner cylinder; 113. End plate; 120. Diffusion plate; 121. Exhaust hole;
200. Susceptor; 300. Reaction chamber; 310. Upper chamber; 320. Necking portion; 330. Lower chamber; 340. Exhaust chamber; 400. gas intake assembly; 510. Upper heating module; 520. Lower heating module; 600. Load lock chamber; 700. Flow guide inner liner; 800. Flow equalizing plate; 810. Adjustment hole; 900. Temperature detection module;
10. Substrate.

### DETAILED DESCRIPTION OF THE EMBODIMENTS

Now, example embodiments will be described more fully with reference to the accompanying drawings. However, the example embodiments can be implemented in various forms and should not be construed as limited to the examples set forth herein; rather, these embodiments are provided so that the present disclosure will be thorough and complete, and will fully convey the concept of the example embodiments to those skilled in the art.

Furthermore, the described features, structures, or characteristics may be combined in any suitable manner in one or more embodiments. In the following description, numerous specific details are provided to give a sufficient understanding of the embodiments of the present disclosure. However, those skilled in the art will recognize that the technical solutions of the present disclosure may be practiced without one or more of the specific details, or other methods, components, devices, steps, etc. may be employed. In other instances, well-known methods, devices, implementations, or operations are not shown or described in detail to avoid obscuring aspects of the present disclosure.

The present disclosure will be further described in detail below with reference to the accompanying drawings and specific embodiments. It should be noted here that the technical features involved in the various embodiments of the present disclosure described below can be combined with each other as long as they do not conflict with each other. The embodiments described below with reference to the drawings are exemplary and are intended to explain the present disclosure and should not be construed as limiting the present disclosure.

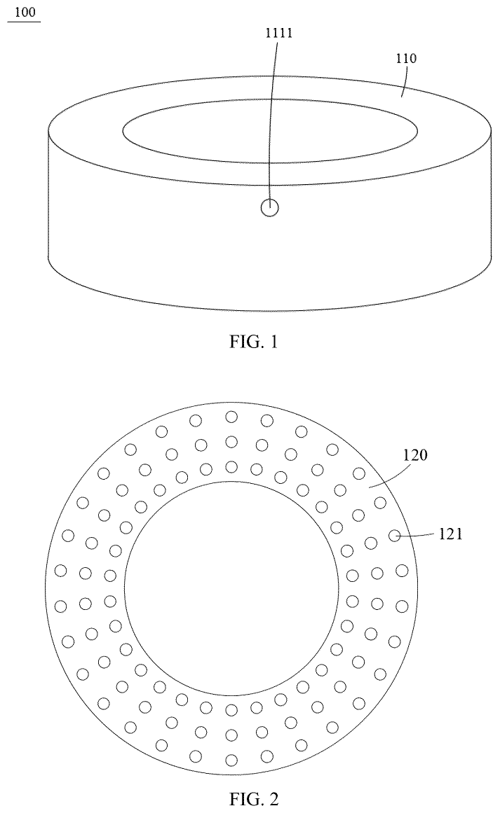

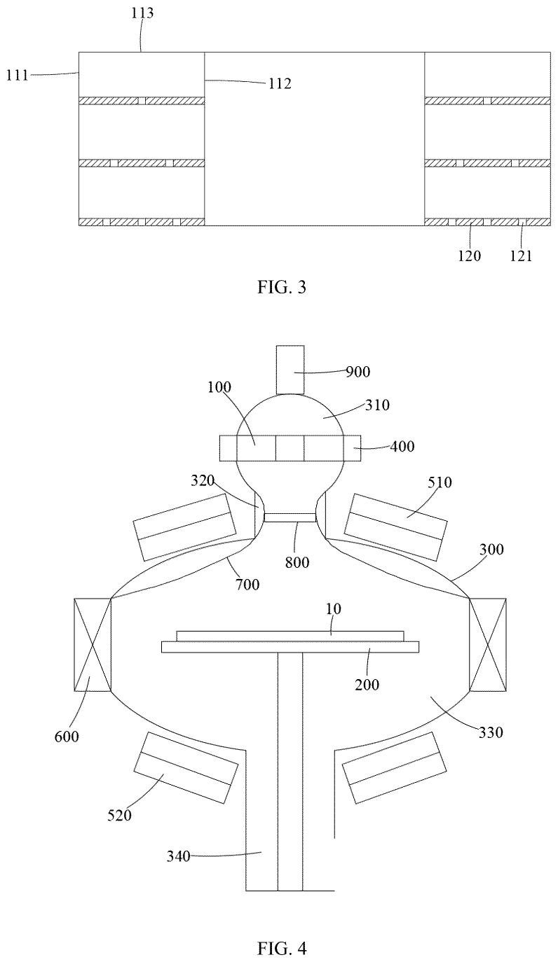

As shown in FIGS. 1 to 3, the annular nozzle 100 in this embodiment includes an annular sleeve 110 and N diffusion plates 120. The annular sleeve 110 includes an outer cylinder 111, an inner cylinder 112, and an end plate 113. The inner cylinder 112 is provided inside the outer cylinder 111, and the outer cylinder 111 and the inner cylinder 112 can be coaxially provided. An annular space is formed between the inner cylinder 112 and the outer cylinder 111. The end plate 113 is provided at one end of the outer cylinder 111 and the inner cylinder 112, and the end plate 113 connects the outer cylinder 111 and the inner cylinder 112.

N diffusion plates 120 are provided in the annular space, N is greater than or equal to 2. N diffusion plates 120 are sequentially spaced apart in the direction away from the end plate 113. Among the N diffusion plates 120, the diffusion plate 120 closest to the end plate 113 is the first diffusion plate 120, and the diffusion plate 120 farthest from the end plate 113 is the Nth diffusion plate 120.

The annular sleeve 110 is provided with gas inlet holes 1111, which are located on the side of the first diffusion plate 120 close to the end plate 113. Each diffusion plate 120 is provided with a plurality of exhaust holes 121 surrounding the inner cylinder 112. For any two adjacent diffusion plates 120: the exhaust holes 121 are provided in a staggered manner, and the number of exhaust holes 121 on the diffusion plates 120 increases sequentially in the direction away from the end plate 113. The exhaust holes 121 in two adjacent diffusion plates 120 are provided in a staggered manner, that is, the centerlines of the exhaust holes 121 are not on the same straight line.

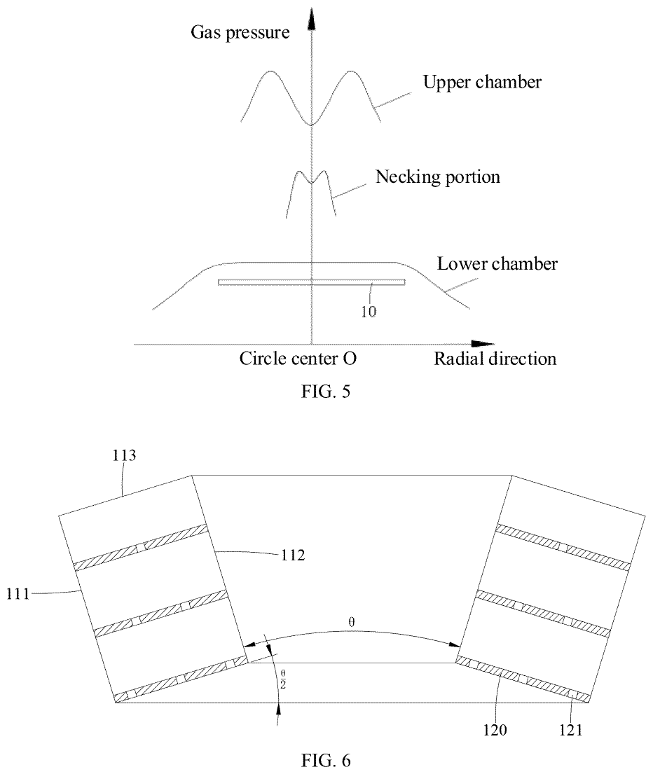

As shown in FIG. 4, when the annular nozzle 100 is applied to the substrate processing device, both the annular nozzle 100 and the susceptor 200 supporting the substrate 10 are provided in the reaction chamber 300, and the annular nozzle 100 is located above the susceptor 200. The process gas ejected by the annular nozzle 100 is distributed in a ring-shaped manner. As the process gas flows downward, it diffuses both inward and outward simultaneously. When the gas flows above the substrate 10 supported by the susceptor 200, the process gas diffuses into a uniformly distributed gas layer over the entire surface. In some implementations, when the annular nozzle 100 is applied to the substrate processing device, the inner chamber of the substrate processing device includes a necking portion 320 between the annular nozzle 100 and the susceptor 200. Then, as the process gas flows downward, it is first compressed inward and then diffuses outward. When flowing above the substrate 10 supported by the susceptor 200, the process gas diffuses into a uniformly distributed gas layer over the entire surface, as shown in FIG. 5, wherein the circle center O represents the center of a cross-section of the reaction chamber 300.

An existing substrate processing device for epitaxial film growth includes a gas intake device, a reaction chamber, and an exhaust device, the gas intake device and the exhaust device are provided on opposite sides of the reaction chamber in the lateral direction of the reaction chamber. The reaction gases introduced by the gas intake device include a middle gas flow widely distributed with a uniform flow rate and narrowly distributed outer gas flows on both sides of the middle gas flow. Since the middle gas flow and the outer gas flows are very close, they quickly mix with each other after entering the reaction chamber, making it difficult to control the uniform distribution of reaction gases above the substrate.

In this embodiment, the annular nozzle 100 includes an annular sleeve 110 and N diffusion plates 120. The annular sleeve 110 includes an outer cylinder 111, an inner cylinder 112, and an end plate 113. The inner cylinder 112 is provided inside the outer cylinder 111, an annular space is formed between the inner cylinder 112 and the outer cylinder 111, the end plate 113 is provided at one end of the outer cylinder 111 and the inner cylinder 112, N diffusion plates 120 are provided in the annular space, N is greater than or equal to 2, the annular sleeve 110 is provided with gas inlet holes 1111 located on the side of the first diffusion plate 120 close to the end plate 113. Each diffusion plate 120 is provided with a plurality of exhaust holes 121 surrounding the inner cylinder 112. For any two adjacent diffusion plates 120, the exhaust holes 121 are provided in a staggered manner, and the number of exhaust holes 121 on the diffusion plates 120 increases sequentially in a direction away from the end plate 113. When the annular nozzle 100 is applied to the substrate processing device, the process gas ejected by the annular nozzle 100 is distributed in a ring-shaped manner. As the process gas flows downward, it diffuses both inward and outward simultaneously. When flowing above the substrate 10 supported by the susceptor 200, the process gas diffuses into a uniformly distributed gas layer over the entire surface, improving the thickness uniformity of the formed film layer.

In some embodiments, the nth diffusion plate 120 is provided with n rings of exhaust holes 121, where 1≤n≤N. For example, if three diffusion plates 120 are provided in the annular space, the first diffusion plate 120 is provided with one ring of exhaust holes 121, the second diffusion plate 120 is provided with two rings of exhaust holes 121, and the third diffusion plate 120 is provided with three rings of exhaust holes 121.

The N diffusion plates 120 are provided in the annular space, and the number of exhaust holes 121 on the diffusion plates 120 gradually increases along the gas flow direction. This design can uniformly disperse the gas, and the diffusion plates 120 are provided at intervals, so that the gas can be mixed in the space between the diffusion plates 120, further improving the uniformity of the process gas distribution.

It should be noted that the nth diffusion plate 120 can be provided with n rings of exhaust holes 121, but it is not limited thereto. The number of rings of exhaust holes 121 on each diffusion plate 120 can be set as required, as long as the number of exhaust holes 121 on the diffusion plates 120 gradually increases along the gas flow direction.

In some embodiments, for any two adjacent diffusion plates 120, the exhaust holes 121 are staggered in the inner-outer direction or in the circumferential direction. In addition, for any two adjacent diffusion plates 120, the exhaust holes 121 can be staggered in the inner-outer direction and in the circumferential direction at the same time. The exhaust holes 121 in two adjacent diffusion plates 120 are staggered in the inner-outer direction, that is, the distance from the centerline of the exhaust holes 121 of the (N−1)th diffusion plate 120 to the centerline of the outer cylinder 111 is different from the distance from the centerline of the exhaust holes 121 of the Nth diffusion plate 120 to the centerline of the outer cylinder 111. The exhaust holes 121 in two adjacent diffusion plates 120 are staggered in the circumferential direction, that is, the centerline of the exhaust holes 121 of the (N−1)th diffusion plate 120 and the centerline of the exhaust holes 121 of the Nth diffusion plate 120 are not in the same radial plane of the outer cylinder 111.

The exhaust holes 121 in any two adjacent diffusion plates 120 are provided in a staggered manner, so that the diffusion plates 120 can uniformly disperse the process gas, improving the uniformity of the process gas distribution.

In some embodiments, the gas inlet holes 1111 are provided on the outer cylinder 111 and located on the side of the first diffusion plate 120 close to the end plate 113. At least one gas inlet hole 1111 is provided.

It should be noted that the gas inlet holes 1111 can be provided on the outer cylinder 111, but they are not limited thereto. The gas inlet holes 1111 can also be provided on the end plate 113 or on the inner cylinder 112, which can be determined as required.

The gas inlet holes 1111 are provided on the outer cylinder 111, which facilitates the gas intake assembly 400 passing through the wall of the reaction chamber 300 to connect the gas inlet holes 1111.

In some embodiments, a plurality of gas inlet holes 1111 are uniformly spaced along the circumferential direction of the outer cylinder 111.

A plurality of gas inlet holes 1111 are uniformly spaced apart along the circumference of the outer cylinder 111, to form a plurality of paths of uniform distributed gas inlet holes, which can reduce the requirement for the diffusion plate 120 to uniformly disperse the gas, and reduce the number of diffusion plates 120, thereby simplifying the structure of the annular nozzle 100 and reducing the manufacturing cost of the annular nozzle 100.

In some embodiments, both the outer cylinder 111 and the inner cylinder 112 are cylindrical.

When both the outer cylinder 111 and the inner cylinder 112 are cylindrical, the structure of the annular nozzle 100 is simpler, which is beneficial to reduce the manufacturing cost of the annular nozzle 100.

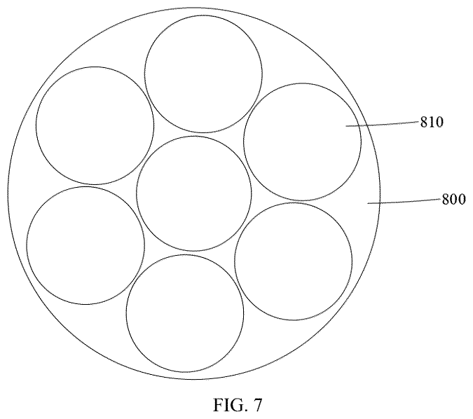

In some embodiments, both the outer cylinder 111 and the inner cylinder 112 are conical, as shown in FIG. 6. The cone angles θ of the outer cylinder 111 and the inner cylinder 112 are both less than 60 degrees, for example, the cone angles θ of the outer cylinder 111 and the inner cylinder 112 are both 1° to 60°. As a preferred implementation, the cone angles θ of the outer cylinder 111 and the inner cylinder 112 are both 20±2°. The diffusion plates 120 are perpendicular to the generatrixes of the outer cylinder 111 and the inner cylinder 112. The first diffusion plate 120 is located on the side close to the conical bottom surface of the outer cylinder 111 and the inner cylinder 112, and the Nth diffusion plate 120 is located on the side close to the conical top surface of the outer cylinder 111 and the inner cylinder 112.

When both the outer cylinder 111 and the inner cylinder 112 are conical, the first diffusion plate 120 is located on the side close to the conical bottom surface of the outer cylinder 111 and the inner cylinder 112, the Nth diffusion plate 120 is located on the side close to the conical top surface of the outer cylinder 111 and the inner cylinder 112, and the direction in which the Nth diffusion plate 120 ejects the process gas is inclined inward, which can increase the inward diffusion of the gas.

It should be noted that the first diffusion plate 120 is located on the side close to the conical bottom surface of the outer cylinder 111 and the inner cylinder 112, and the Nth diffusion plate 120 is located on the side close to the conical top surface of the outer cylinder 111 and the inner cylinder 112, but it is not limited thereto. The Nth diffusion plate 120 can also be provided on the side close to the conical bottom surfaces of the outer cylinder 111 and the inner cylinder 112, and the first diffusion plate 120 can be provided on the side close to the conical top surfaces of the outer cylinder 111 and the inner cylinder 112, so that the direction in which the Nth diffusion plate 120 ejects the process gas is inclined outward to increase the outward diffusion of the gas, which can be determined as required.

The present disclosure also provides a substrate processing device, which includes the above-disclosed annular nozzle 100, a susceptor 200, a reaction chamber 300, and a gas intake assembly 400, as shown in FIG. 4. The reaction chamber 300 includes an upper chamber 310 and a lower chamber 330 that are in communication with each other. The susceptor 200 is provided in the lower chamber 330 and is used for supporting the substrate 10 to be processed. The annular nozzle 100 is provided in the upper chamber 310, and the Nth diffusion plate 120 of the annular nozzle 100 is located on the side of the annular nozzle 100 close to the susceptor 200. The gas intake assembly 400 passes through the wall of the reaction chamber 300 to connect the gas inlet holes 1111 of the annular nozzle 100. The gas intake assembly 400 is used for introducing process gases, which include reaction gases or purge gases.

When the substrate processing device works: the process gas ejected by the annular nozzle 100 is distributed in a ring-shaped manner. As the process gas flows downward, it diffuses both inward and outward simultaneously. When flowing above the substrate 10 supported by the susceptor 200, the process gas diffuses into a uniformly distributed gas layer over the entire surface, so that a film layer with uniform thickness can be formed on the surface of the substrate 10.

An existing substrate processing device includes a gas intake device, a reaction chamber, and an exhaust device, which are provided on opposite sides of the reaction chamber in the lateral direction of the reaction chamber. The reaction gases introduced by the gas intake device include a middle gas flow widely distributed and having a uniform flow rate and narrowly distributed outer gas flows on both sides of the middle gas flow. Since the middle gas flow and the outer gas flows are very close, they quickly mix with each other after entering the reaction chamber, making it difficult to control the uniform distribution of reaction gases above the substrate. Therefore, when processing the substrate with the existing substrate processing device, the susceptor supporting the substrate needs to drive the substrate to rotate at a high speed to improve the uniformity of the formed film layer.

In this embodiment, when the substrate processing device processes the substrate 10, the process gas ejected by the annular nozzle 100 is distributed in a ring-shaped manner, and may be non-uniformly distributed. As the process gas flows downward, it diffuses inward and outward simultaneously, and when it reaches the upper part of the substrate 10 supported by the susceptor 200, the process gas diffuses into a uniformly distributed gas layer over the entire surface. Due to the improved uniformity of the process gas distribution, the rotation speed of the substrate 10 can be reduced or even eliminated, avoiding the contamination in the chamber caused by the rotation of the susceptor 200. Moreover, the structure of the substrate processing device can be designed to be simpler, so as to reduce the manufacturing cost of the substrate processing device.

In some embodiments, the reaction chamber 300 further includes a necking portion 320. The necking portion 320 connects the upper chamber 310 and the lower chamber 330. The outer edges of the orthographic projections of the upper chamber 310, the lower chamber 330, and the Nth diffusion plate 120 on the susceptor 200 are all located outside that of the necking portion 320. In other words, the necking portion 320 is contracted inward relative to the upper chamber 310 and the lower chamber 330.

When the substrate processing device works, the process gas ejected by the annular nozzle 100 is distributed in a ring-shaped manner. As the process gas flows downward, when entering the necking portion 320, the process gas will first be compressed inward because the necking portion 320 is contracted inward relative to the upper chamber 310 and the lower chamber 330. After passing through the necking portion 320, the process gas will diffuse inward and outward simultaneously, and when it flows to the upper part of the substrate 10 supported by the susceptor 200, it diffuses into a uniformly distributed gas layer over the entire surface, as shown in FIG. 5.

The process gas is first compressed inward to make the gas distribution tend to be uniform, and then diffuses inward and outward simultaneously to form a uniformly distributed gas layer over the entire surface, which improves the uniformity of the process gas distribution.

In some embodiments, the substrate processing device further includes an upper heating module 510. The upper heating module 510 is provided around the necking portion 320. The lower chamber 330 includes a transmissive chamber wall. The upper heating module 510 can emit electromagnetic waves, and the electromagnetic waves can pass through the transmissive chamber wall to heat the substrate 10.

The upper heating module 510 is provided around the necking portion 320, and the necking portion 320 is contracted inward relative to the upper chamber 310 and the lower chamber 330, which increases the space for installing the upper heating module 510.

In some embodiments, the reaction chamber 300 further includes an exhaust chamber 340. The exhaust chamber 340 is located on the side of the lower chamber 330 away from the necking portion 320, and an exhaust port is formed on the chamber wall of the exhaust chamber 340. The substrate processing device further includes a lower heating module 520. The lower heating module 520 is provided around the exhaust chamber 340. The lower chamber 330 includes a transmissive chamber wall. The lower heating module 520 can emit electromagnetic waves, and the electromagnetic waves can pass through the transmissive chamber wall to heat the substrate 10.

The heating modules are provided on the opposite upper and lower sides of the lower chamber 330 to heat the substrate 10 simultaneously from above and below, which can not only improve the heating speed but also improve the temperature uniformity in the lower chamber 330.

It should be noted that the substrate processing device can be provided with both the upper heating module 510 and the lower heating module 520, but it is not limited thereto. The substrate processing device can also be provided with one of the upper heating module 510 and the lower heating module 520, which can be determined according to the actual situation.

In some embodiments, the inner walls of at least the upper chamber 310, the necking portion 320, the lower chamber 330, and the exhaust chamber 340 of the reaction chamber 300 are made of quartz material, and the connection portion between the upper chamber 310 and the necking portion 320, between the necking portion 320 and the lower chamber 330, and between the lower chamber 330 and the exhaust chamber 340 can be welded by quartz welding.

Parts of the inner chamber of the reaction chamber 300 can be connected to each other by quartz welding. The quartz material has good thermal stability, which can ensure the normal operation of the reaction chamber 300.

It should be noted that the connection portion between the upper chamber 310 and the necking portion 320, between the necking portion 320 and the lower chamber 330, and between the lower chamber 330 and the exhaust chamber 340 can be welded by quartz welding, but it is not limited thereto. For the connection portions that are not directly exposed to the heating areas of the upper heating module 510 and the lower heating module 520, O-ring seals with cooling water functions can also be used, which can be determined according to the actual situation.

In some embodiments, the substrate processing device further includes a load lock chamber 600. The load lock chamber 600 is provided on the opposite sides of the lower chamber 330 in the horizontal direction. The load lock chamber 600 is used for moving the substrate 10 to be processed into the lower chamber 330 and moving the processed substrate 10 out of the lower chamber 330. The connection portion between the load lock chamber 600 and the lower chamber 330 can be sealed by an O-ring with a cooling water function.

The connection portion between the load lock chamber 600 and the lower chamber 330 is not directly exposed to the heating areas of the upper heating module 510 and the lower heating module 520. The use of an O-ring seal with a cooling water function can simplify the structure of the substrate processing device and reduce the manufacturing cost of the substrate processing device.

In some embodiments, the substrate processing device further includes a flow guide liner 700. The flow guide liner 700 is connected to the inner wall of the reaction chamber 300. The flow guide liner 700 at least covers the inner wall of the necking portion 320. The inner surface of the flow guide liner 700 and the inner wall of the upper chamber 310 form a streamline inner chamber, which reduces the difficulty of gas diffusion and improves the uniformity of gas distribution. The flow guide liner 700 can be made of quartz material.

For example, the inner surface of one end of the flow guide liner 700 is smoothly connected with the inner surface of the upper chamber 310, and the other end of the flow guide liner 700 extends to the load lock chamber 600. The inner surface of the flow guide liner 700 is smoothly connected with the inner surface of the upper chamber 310, that is, they are connected by a curve without sharp corners or turns, further reducing the influence of twists and turns of the chamber wall on gas diffusion. The annular nozzle 100 is located on the side of the connection portion between the flow guide liner 700 and the upper chamber 310 away from the lower chamber 330.

The flow guide liner 700 is used to guide the flow, to eliminate the sharp corners in the inner chamber of the reaction chamber 300, thereby avoiding the sharp corners in the inner chamber of the reaction chamber 300 from affecting the outward diffusion of the process gas, thus the uniformity of the process gas distribution can be improved.

In some embodiments, the upper heating module 510 can emit electromagnetic waves, and the electromagnetic waves can pass through the flow guide liner 700 to heat the substrate 10.

The flow guide liner 700 can not only play a role in guiding the flow but also do not affect the upper heating module 510 to heat the substrate 10, and do not affect the substrate processing device to process the substrate 10.

As shown in FIG. 4 and FIG. 7, the substrate processing device further includes a flow equalizing plate 800. The flow equalizing plate 800 is provided in the necking portion 320. The flow equalizing plate 800 is provided with a plurality of adjustment holes 810, and the adjustment holes 810 are used to adjust the distribution uniformity of the process gas at the substrate 10 that enters the lower chamber 330 through the flow equalizing plate 800. It should be understood that the sizes and positions of different adjustment holes 810 on the flow equalizing plate 800 can be set according to the distribution of the process gas before passing through the flow equalizing plate 800, so that after passing through the flow equalizing plate 800, the process gas entering the lower chamber 330 is more uniformly distributed at the substrate 10.

The flow equalizing plate 800 is provided in the necking portion 320 to carry out secondary adjustment on the distribution of the process gas, which can further improve the uniformity of the process gas distribution.

It should be noted that the flow equalizing plate 800 can be provided in the necking portion 320 to carry out secondary adjustment on the distribution of the process gas, but it is not limited thereto. When the annular sleeve 110 is provided with a plurality of gas inlet holes 1111, the distribution of the process gas can also be adjusted by adjusting the gas flow rate of each gas inlet hole 1111, which can be determined according to the actual situation.

In some embodiments not shown in the figures, the inner surface of the necking portion 320 is smoothly connected with the inner surface of the upper chamber 310 and the inner surface of the lower chamber 330 to form a streamline inner chamber.

The necking portion 320 is smoothly connected with the upper chamber 310 and the lower chamber 330 to form a streamline inner chamber, eliminating the sharp corners in the inner chamber of the reaction chamber 300, avoiding the sharp corners in the inner chamber of the reaction chamber 300 from affecting the outward diffusion of the process gas, thus the uniformity of the process gas distribution can be improved.

In some embodiments, the substrate processing device further includes a temperature detection module 900. The temperature detection module 900 is provided on the side of the upper chamber 310 away from the susceptor 200, and can be specifically provided inside or outside the upper chamber 310. The orthographic projection of the probe of the temperature detection module 900 on the susceptor 200 is located inside the orthographic projection of the inner cylinder 112 of the annular nozzle 100 on the susceptor 200.

The orthographic projection of the probe of the temperature detection module 900 on the susceptor 200 is located inside the orthographic projection of the inner cylinder 112 of the annular nozzle 100 on the susceptor 200. That is to say, the annular nozzle 100 will not block the detection signal emitted or received by the temperature detection module 900, which can improve the detection accuracy of the temperature detection module 900.

Exemplarily, the substrate processing device is an epitaxial device, which is used for preparing an epitaxial layer on the substrate 10.

Terms such as “first” and “second” are only used for descriptive purposes and cannot be understood as indicating or implying relative importance or implicitly specifying the number of indicated technical features. Thus, features defined with “first”, “second”, etc. may explicitly or implicitly include one or more of such features. In the description of the present disclosure, “a plurality of” means two or more, unless otherwise specifically defined.

In the present disclosure, unless otherwise clearly specified and limited, terms such as “assemble” and “connect” should be understood in a broad sense. For example, they may be fixedly connected, detachably connected, or integrated; they may be mechanically connected or electrically connected; they may be directly connected, or indirectly connected through an intermediate medium, or the internal communication of two components or the interaction relationship between two components. For those skilled in the art, the specific meanings of the above terms in the present disclosure can be understood according to specific situations.

In the description of this specification, the description referring to terms such as “some embodiments” and “exemplarily” means that specific features, structures, materials, or characteristics described in conjunction with the embodiment or example are included in at least one embodiment or example of the present disclosure. In this specification, the schematic representations of the above terms do not necessarily refer to the same embodiment or example. Moreover, the described specific features, structures, materials, or characteristics may be combined in any suitable manner in any one or more embodiments or examples. In addition, those skilled in the art can combine and combine the different embodiments or examples and the features of the different embodiments or examples described in this specification without conflicting with each other.

Although the embodiments of the present disclosure have been shown and described above, it can be understood that the above embodiments are exemplary and should not be construed as limiting the present disclosure. Those skilled in the art can make changes, modifications, substitutions, and variations to the above embodiments inside the scope of the present disclosure. Therefore, any changes or modifications made according to the claims and the specification of the present disclosure shall fall inside the scope covered by the patent of the present disclosure.

What is claimed is:

1. An annular nozzle, comprising:
an annular sleeve, comprising an outer cylinder, an inner cylinder, and an end plate; wherein the inner cylinder is provided inside the outer cylinder, an annular space is formed between the outer cylinder and the inner cylinder, the end plate is provided at one end of the outer cylinder and the inner cylinder, and the end plate connects the outer cylinder and the inner cylinder; and
at least two diffusion plates, provided in the annular space, sequentially spaced apart in a direction away from the end plate;
wherein a diffusion plate closest to the end plate is referred to as a first diffusion plate; the annular sleeve is provided with a gas inlet hole, and the gas inlet hole is located on a side of the first diffusion plate close to the end plate; each diffusion plate is provided with a plurality of exhaust holes surrounding the inner cylinder; and for any two adjacent diffusion plates, the plurality of exhaust holes are provided in a staggered manner, and a number of the plurality of exhaust holes on each diffusion plate increases sequentially in the direction away from the end plate.

2. The annular nozzle according to claim 1, wherein a nth diffusion plate is provided with n rings of the plurality of exhaust holes, where 1≤n≤N, and N is referred to as a number of the at least two diffusion plates.

3. The annular nozzle according to claim 1, wherein in any two adjacent diffusion plates, the plurality of exhaust holes are staggered radially and/or circumferentially.

4. The annular nozzle according to claim 1, wherein the gas inlet hole is provided on the outer cylinder.

5. The annular nozzle according to claim 4, wherein a plurality of gas inlet holes are evenly spaced apart along a circumference of the outer cylinder.

6. The annular nozzle according to claim 1, wherein the outer cylinder and the inner cylinder are cylindrical or conical cylinder.

7. The annular nozzle according to claim 6, wherein the outer cylinder and the inner cylinder are conical cylinder, cone angles of the outer cylinder and the inner cylinder are less than 60 degrees.

8. The annular nozzle according to claim 7, wherein each diffusion plate is perpendicular to a generatrix of the outer cylinder and that of the inner cylinder.

9. The annular nozzle according to claim 7, wherein a diffusion plate farthest from the end plate is referred to as a Nth diffusion plate, located on a side of the first diffusion plate closer to an apex of the conical cylinder.

10. A substrate processing device, comprising:
a reaction chamber, comprising an upper chamber and a lower chamber in communication with each other;
a susceptor, provided in the lower chamber, wherein the susceptor is configured to support a substrate to be processed;
an annular nozzle, provided in the upper chamber; and
a gas intake assembly, configured to introduce process gas;
wherein the annular nozzle comprises: an annular sleeve, comprising an outer cylinder, an inner cylinder, and an end plate; wherein the inner cylinder is provided inside the outer cylinder, an annular space is formed between the outer cylinder and the inner cylinder, the end plate is provided at one end of the outer cylinder and the inner cylinder, and the end plate connects the outer cylinder and the inner cylinder; and at least two diffusion plates provided in the annular space, sequentially spaced apart in a direction away from the end plate; wherein a diffusion plate closest to the end plate is referred to as a first diffusion plate; the annular sleeve is provided with a gas inlet hole, and the gas inlet hole is located on a side of the first diffusion plate close to the end plate; each diffusion plate is provided with a plurality of exhaust holes surrounding the inner cylinder; and for any two adjacent diffusion plates, the plurality of exhaust holes are provided in a staggered manner, and a number of the plurality of exhaust holes on each diffusion plate increases sequentially in the direction away from the end plate;
a diffusion plate farthest from the end plate is referred to a Nth diffusion plate, and the Nth diffusion plate is located on a side of the first diffusion plate closer to the susceptor; and
the gas intake assembly is connected to the gas inlet hole of the annular nozzle.

11. The substrate processing device according to claim 10, wherein the reaction chamber further comprises a necking portion connecting the upper chamber and the lower chamber; and outer edges of orthographic projections of the upper chamber, the lower chamber, and the Nth diffusion plate onto the susceptor are all located outside that of the necking portion.

12. The substrate processing device according to claim 11, further comprising:
an upper heating module provided around the necking portion, wherein the lower chamber comprises a first transmissive chamber wall, and the upper heating module is capable of emitting electromagnetic waves passing through the first transmissive chamber wall to heat the substrate.

13. The substrate processing device according to claim 11, further comprising:
a flow guide liner, wherein the flow guide liner is connected to an inner wall of the reaction chamber, and covers at least an inner wall of the necking portion, and an inner surface of the flow guide liner and an inner wall of the upper chamber form a streamline inner chamber.

14. The substrate processing device according to claim 13, wherein the inner surface of the flow guide liner is smoothly connected to an inner surface of the upper chamber, and the annular nozzle is located on a side of a connection portion between the flow guide liner and the upper chamber away from the lower chamber.

15. The substrate processing device according to claim 13, wherein an end of the flow guide liner away from the upper chamber is connected to the lower chamber, the substrate processing device further comprises an upper heating module provided around the necking portion, the upper heating module is capable of emitting electromagnetic waves, passing through the flow guide liner to heat the substrate.

16. The substrate processing device according to claim 11, further comprising:
a flow equalizing plate provided in the necking portion, wherein the flow equalizing plate is provided with a plurality of adjustment holes for adjusting a distribution uniformity at the substrate of process gas entering the lower chamber through the flow equalizing plate.

17. The substrate processing device according to claim 11, wherein an inner surface of the necking portion is smoothly connected to an inner surface of the upper chamber and an inner surface of the lower chamber, to form a streamline inner chamber.

18. The substrate processing device according to claim 11, wherein the reaction chamber further comprises an exhaust chamber, located on a side of the lower chamber away from the necking portion, and an exhaust port is formed on a chamber wall of the exhaust chamber.

19. The substrate processing device according to claim 18, wherein the substrate processing device further comprises a lower heating module provided around the exhaust chamber, the lower chamber comprises a second transmissive chamber wall and the lower heating module is capable of emitting electromagnetic waves passing through the second transmissive chamber wall to heat the substrate.

20. The substrate processing device according to claim 10, further comprising:
a temperature detection module provided on a side of the upper chamber away from the susceptor, wherein an orthographic projection of a probe of the temperature detection module onto the susceptor is located inside that of the inner cylinder.
